(19) United States
(12) Patent Application Publication
(10) Pub. No.: US 2020/0272956 A1
(43) Pub. Date: Aug. 27, 2020

(54) Sensor and Machine Learning-Based Office Space Stacking Optimization System and Method

(71) Applicant: Effective Technology Solutions, Inc., Mountain View, CA (US)

(72) Inventor: Noam Livnat, Mountain View, CA (US)

(21) Appl. No.: 16/798,399

(22) Filed: Feb. 23, 2020

Related U.S. Application Data
(60) Provisional application No. 62/809,639, filed on Feb. 24, 2019.

(51) Int. Cl. G06Q 10/04; G06N 20/00; G06Q 10/10; G16Y 40/35

(52) U.S. Cl. CPC G06Q 10/047; G16Y 40/35; G06Q 10/10; G06N 20/00

(57) ABSTRACT

A novel electronic system is configured to generate various office space stacking scenarios based on dynamic input parameters originating from office space-installed sensors, organization-insensitive external data, and organization-specific internal data. An office space stacking scenario involves an organization's plan to relocate employees and/or business units to achieve an optimized objective, such as an improved office lease-related cost controls or productivity within the organization. The novel electronic system also provides an autonomous machine determination of most optimal office space stacking scenarios after generating a plurality of computer-simulated scenarios, even without a human operator intervention. The office space-installed sensors (e.g. passive infrared sensors, machine-vision sensors, Bluetooth beacons) in the novel electronic system provide insightful and objective information on office space utilizations, wasted office space areas, and worker productivity and collaboration levels in real time to enable accurate machine determinations of optimal office space stacking scenarios that are worthy of real-life implementation.

### BACKGROUND OF THE INVENTION

The present invention generally relates to intelligent machine determination of office space allocations, management, and optimizations. More specifically, the present invention relates to electronic or optical sensor and intelligent machine learning-based real estate stacking optimization systems and methods of operating such systems.

An office space serves as a primary work environment for various organizations and their employees. The office space also incurs one of the largest expenses for an organization outside of payroll expenditures. Because the office space-related expenses and the management of such spaces have a large impact on corporate finances as well as workers' experience and productivity, efficient management of the office space environment is critical to the success of the organization.

The workplace, encompassing everything from the real estate housing the office to the amenities offered to employees, is a very dynamic environment, with its pace of change ever increasing in an ultra-competitive and globalized business environment. Companies and organizations need to constantly deal with these changes and seek continuous optimization of their costs and return on investment (ROI) in the workplace. Some of the key ongoing changes that have substantial impact on the workplace include, but are not limited to, property-related event deadlines (e.g. lease signing, expiration, other property-related key dates, etc.), employee-related dynamics as they join or leave a particular employer, and in-house movements of workers as they relocate or transfer within an organization, which can happen in the same physical location or in different floors, buildings, states, or countries.

Therefore, many organizations are increasingly under significant pressure to optimize their office spaces or other real estate assets to improve their organizational efficiency, productivity, and profitability. An important component for this effort is referred to as “stacking” or “restacking”. A “stacking” is a process through which business units or groups within an organization are allocated areas or workspaces in a particular location (e.g. 35 desks for Marketing on the 5th floor of Building A, 45 desks on the same floor for Sales, 53 desks on the 6th floor of Building A for Engineering, etc.). Likewise, a “restacking” is a process involving a reallocation or a modification to a previous “stacking” process in the organization.

Depending on particular needs of the organization, the objectives of a restacking effort may vary. In one case, a close physical proximity of consolidated teams is paramount. For instance, all members of the sales department in the organization may need to be on the same floor for intra-team and in-person communications and concerted sales efforts. In another case, minimizing office space cost may be the primary objective. For example, splitting the sales department across two smaller floors and discontinuing the current lease on a large but more expensive single floor may lower office lease expenses to the organization. Moreover, in another situation, minimizing organizational disruptions (e.g. moving fewest people to new locations, etc.) may be the most important criteria for restacking. Other potential considerations for stacking or restacking activities include, but are not limited to, relocation costs, construction costs, and office decorations and fitting costs.

Regardless of specific and desired objectives of the organization, the stacking or the restacking process can be arduous when conducted manually (i.e. without artificial intelligence and intelligent machine decision-making), as it is traditionally performed by human coordinators alone. In particular, the number of parameters typically taken into account as either quantitative inputs to the stacking/restacking process (e.g. cost of an individual move, cost of upgrading an HVAC system to accommodate new equipment, etc.) or as qualitative preferences (e.g. the sales department needs to be at least on adjacent floors with the marketing department, the engineering department must be on the same floor as the quality assurance department, etc.) can become overwhelmingly large and complicated for human coordinators. Even in a relatively simple stacking or restacking process with only a few parameters, a manual human coordination process to configure and quantify the desired optional scenarios and consider their pros and cons are often labor intensive, time consuming, and costly.

Furthermore, although restacking is sometimes limited to a single building or a single site, it is often performed at a larger scale, encompassing multiple sites or geographic regions. As a result, the number of potential scenarios and permutations for space allocations during the stacking or restacking process can become overwhelmingly complicated, with fewer opportunities for achieving space, cost, and/or organization efficiencies desired by the initial stacking/restacking objectives.

Therefore, it may be desirable to devise a novel electronic system incorporating machine learning and artificial intelligence that synthesizes and recommends one or more stacking or restacking scenarios for office space allocations after autonomous machine analysis and determinations from office space utilization datasets and desired stacking or restacking objectives.

Furthermore, it may also be desirable to devise a novel electronic system that incorporates IoT sensors and machine learning to create and visualize optimized stacking or restacking scenarios for office space management.

In addition, it may also be desirable to devise a method of operating such novel electronic systems that incorporate machine learning, artificial intelligence, and/or IoT sensors to create, visualize, and modify various machine-optimized stacking or restacking scenarios for office space management.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In a preferred embodiment of the invention, a sensor and machine learning-based office space stacking optimization system is disclosed. This system comprises: (1) a human or object detection sensor installed in an office space to identify or detect presence of one or more employees; (2) a sensor and machine learning-based office space stacking optimization module comprising a sensor data decoder operatively connected to the human or object detection sensor, an organization-insensitive restacking database, an organization-specific restacking database, an office space restacking coordinator preferences module, a restacking history data management module, a machine-created restacking scenario accumulator and management module, and an autonomous machine restacking determination unit that discovers, without a human operator intervention, a best-performing potential restacking scenario for office space cost reduction or worker productivity improvement for the office space, wherein the best-performing potential restacking scenario is quantified by an optimization algorithm incorporating an objective or cost function that compares one computer-generated restacking scenario's office space cost reduction or worker productivity improvement against other computer-generated restacking scenarios, and wherein the sensor and machine learning-based office space stacking optimization module is executed on a computer server; (3) an organization-insensitive external dataset entered into the organization-insensitive restacking database in the sensor and machine learning-based office space stacking optimization module; (4) an organization-specific internal dataset entered into the organization-specific restacking database; (5) a user-provided office space restacking preference parameter entered into the office space restacking coordinator preferences module in the sensor and machine learning-based office space stacking optimization module; and (6) a data network operatively connecting the human or object detection sensor in the office space and the sensor and machine learning-based office space stacking optimization module executed in the computer server.

### BRIEF DESCRIPTION OF DRAWINGS

FIG. 1 shows a system block diagram for a sensor and machine learning-based office space stacking optimization system, in accordance with an embodiment of the invention.

FIG. 2 shows an embodiment of a sensor and machine learning-based office space stacking optimization module, in accordance with an embodiment of the invention.

FIG. 3 shows a high-level dataflow diagram for restacking scenario creation for the sensor and machine learning-based office space stacking optimization system, in accordance with an embodiment of the invention.

FIG. 4 shows a detailed dataflow diagram for restacking scenario creation for the sensor and machine learning-based office space stacking optimization system, in accordance with an embodiment of the invention.

FIG. 5 shows an example of a cost efficiency-prioritizing office space stacking optimization algorithm, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of descriptions of shapes, configurations, and/or other symbolic representations that directly or indirectly resemble one or more sensor and machine learning-based office space stacking optimization systems and methods of operating such systems. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention does not inherently indicate any particular order nor imply any limitations in the invention.

For the purpose of describing the invention, a term herein referred to as “stacking” is defined as a process through which business units or groups within an organization are allocated areas or workspaces in a particular location. Similarly, a term herein referred to as “restacking” is defined as a process involving a reallocation or a modification to a previous “stacking” process in the organization.

Moreover, a term herein referred to as a “sensor,” an “environmental sensor,” or an “loT sensor” is defined as an electronic sensing device capable of detecting and determining environmental variables, such as changes in nearby population, foot traffic, temperature, CO2 levels, humidity, sound/noise level, physical structures, dimensions, etc. If the sensor is connected to an office space stacking optimization system by the Internet and continuously or periodically transfers the environmental variables to the system, then that sensor is called an “loT sensor.”

In addition, a term herein referred to as “floorplan” or “plan” is defined as one or more computer graphics-generated hypothetical office space arrangement, employee relocation, seat assignment or allocation, and/or modification scenarios arising from a stacking or restacking process, which may or may not be implemented in real life. Multiple floorplans can be sequentially associated as sequential future instances originating from an initial stacking floorplan that serves as a real-life or hypothetically-simulated origin for future changes made to the initial stacking floorplan. Multiple stacking or restacking floorplans that create multiple and separate sequential future instances for each initial stacking floorplan are also supported by various embodiments of the present invention. Furthermore, multiple derivative floorplans branching out from a sequential future instance of an initial stacking floorplan are also provided by various embodiments of the present invention.

Moreover, for the purpose of describing the invention, a term herein referred to as “potential future office stacking floorplan” is defined as one particular instance of a time-sequenced and hypothetically-implementable future plan, which is derived from an initial stacking plan or another earlier-date floorplan.

In addition, for the purpose of describing the invention, a term herein referred to as “space,” “workspace,” “real estate,” or “office space,” is defined as business, corporate, academic, government, or public premises that may be utilized by one or more group of people. For example, a “space” may be an office floor, a conference room, a private office, a cubicle area, an auditorium, or a lunch room in a corporate building.

Furthermore, for the purpose of describing the invention, a term herein referred to as a “module” is defined as a specialized logical component comprising one or more software and/or chip-encoded hardware logical units that perform special-purpose task(s) and function(s) to enable specialized functionalities in a sensor and machine learning-based office space stacking optimization system.

One aspect of an embodiment of the present invention is providing a novel electronic system that incorporates machine learning and artificial intelligence to synthesize and recommend one or more stacking or restacking scenarios for office space allocations after autonomous machine analysis and determinations from office space utilization datasets and desired stacking or restacking objectives, even without human operator interventions.

Furthermore, another aspect of an embodiment of the present invention is providing a novel electronic system that incorporates IoT sensors and machine learning to create and/or visualize optimized stacking or restacking scenarios for office space management.

Yet another aspect of an embodiment of the present invention is providing a method of operating such novel electronic systems that incorporate machine learning, artificial intelligence, and/or IoT sensors to create, visualize, and modify various machine-optimized stacking or restacking scenarios for office space management.

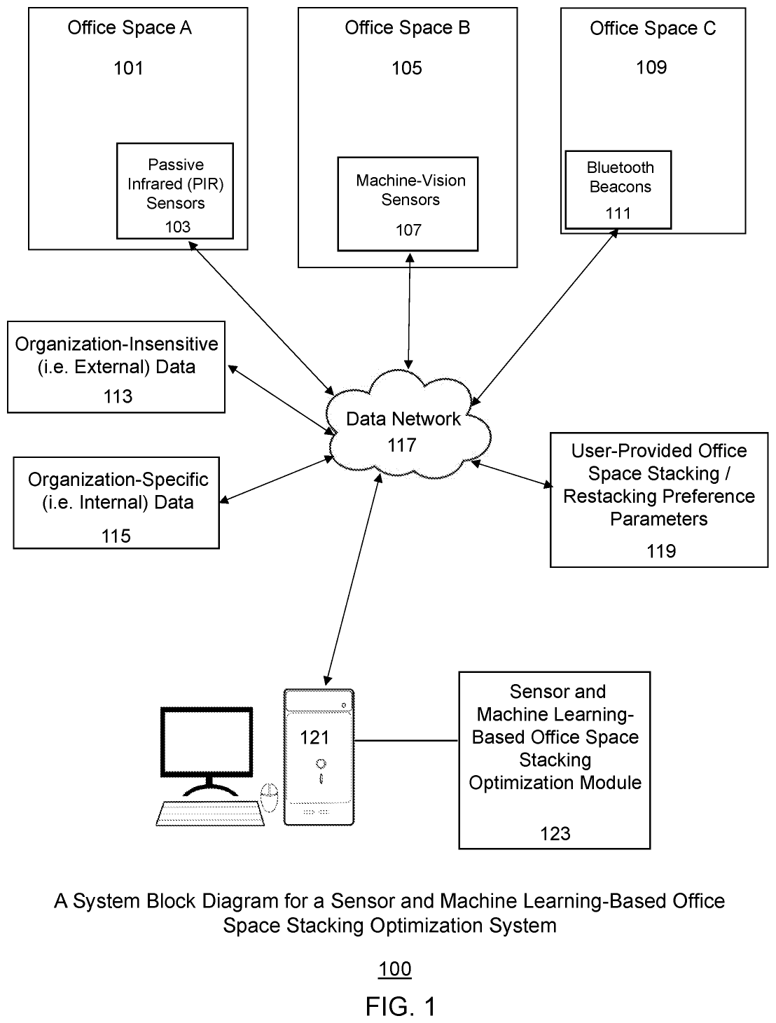

FIG. 1 shows a system block diagram (100) for a sensor and machine learning-based office space stacking optimization system, in accordance with an embodiment of the invention. In this preferred embodiment of the invention, the sensor and machine learning-based office space stacking optimization system comprises a plurality of sensor devices (103, 107, 111) located in a plurality of office space areas (101, 105, 109), which are operatively connected to a sensor and machine learning-based office space stacking optimization module (123) executed in a CPU and a memory unit of a computer server (121), a portable electronic device, a cloud-computing network resource, or a combination thereof. The plurality of office space areas (101, 105, 109) shown as “Office Space A,” “Office Space B,” and “Office Space C,” may represent multiple office floors in one building, various office spaces spread among a plurality of buildings, or compartmentalized sections of one office floor.

The sensor and machine learning-based office space stacking optimization module (123) is configured to receive, store, decode, and interpret organization-insensitive (i.e. external) data (113), organization-specific (i.e. internal) data (115), user-provided office space stacking or restacking preference parameters (119), and a plurality of real-time sensor data streams from the plurality of sensor devices (103, 107, 111) via a data network (117), as shown in the system block diagram (100) in FIG. 1. Types of sensor devices may include, but are not limited to, passive infrared (PIR) sensors (103), machine-vision sensors (107), and Bluetooth beacons (111) that can autonomously detect and determine real-time presence of humans and geometrical configurations and office space conditions related to office furniture, wall dividers, current occupancy, and usable or vacant square footage estimations, even without human operator interventions. In addition, the data network (117) is a cellular communication network, a wireless LAN, a satellite communication network, a wired cable communication network, or a combination thereof.

Furthermore, the organization-specific data (115) may also include meeting room schedules, personal schedules, email, text chat, or other communication metadata that may be provided directly by users in the user-provided office space stacking or restacking preference parameters (119). In some embodiments, even when users are not providing information proactively to the system, employee meeting room schedules, personal schedules, and various email, text, and other human communication metadata may be independently gathered and analyzed by the sensor and machine learning-based office space stacking optimization module (123) as part of a machine-learning process for deriving optimized office space stacking or restacking scenarios.

In this embodiment of the invention, sensory information and readout values transmitted from the plurality of sensor devices to the sensor and machine learning-based office space stacking optimization module (123) are analyzed in conjunction with the organization-insensitive data (113), the organization-specific data (115), and the user-provided office space stacking or restacking preference parameters (119) to determine and synthesize one or more machine-optimized office space stacking/restacking scenarios and to display such machine-optimized scenarios a human office space management coordinator via a computerized user interface.

Furthermore, in some embodiments of the invention, the sensor and machine learning-based office space stacking optimization module (123) is also capable of autonomously and proactively generating an “office space restacking need” alert during the course of a machine learning-based autonomous monitoring of actual office space arrangement changes over a specific period of time (e.g. monthly, quarterly, yearly, etc.), based on system operator-specified optimization priorities. For example, a human office space management coordinator may specify the optimization priorities to be cost efficiency, distance minimization, or overall productivity maximation. Based on such operator-specified office space restacking optimization priorities, the sensor and machine learning-based office space stacking optimization module (123) can generate the “office space restacking need” alert, if dynamically-changing variables associated with such optimization priorities (e.g. cost efficiency, distance minimization, overall productivity, etc.) become excessively inefficient beyond corresponding threshold values.

In one instance, the sensor and machine learning-based office space stacking optimization module (123) may detect that the leasing costs of multiple office spaces just exceeded an acceptable threshold value of an organization after a recent change to the organization. In another instance, the sensor and machine learning-based office space stacking optimization module (123) may detect that the overall productivity of the organization is dropping below an acceptable productivity threshold value, based on an analysis of real-time environmental sensor information that measures, for example, employee foot traffic, underutilized office meeting rooms or spaces, and trends in meeting frequencies or cancellations. In such instances, the sensor and machine learning-based office space stacking optimization system is able to intelligently, dynamically, and autonomously generate an “office space restacking need” alert based on the organization's office space management priorities, even without a human operator intervention.

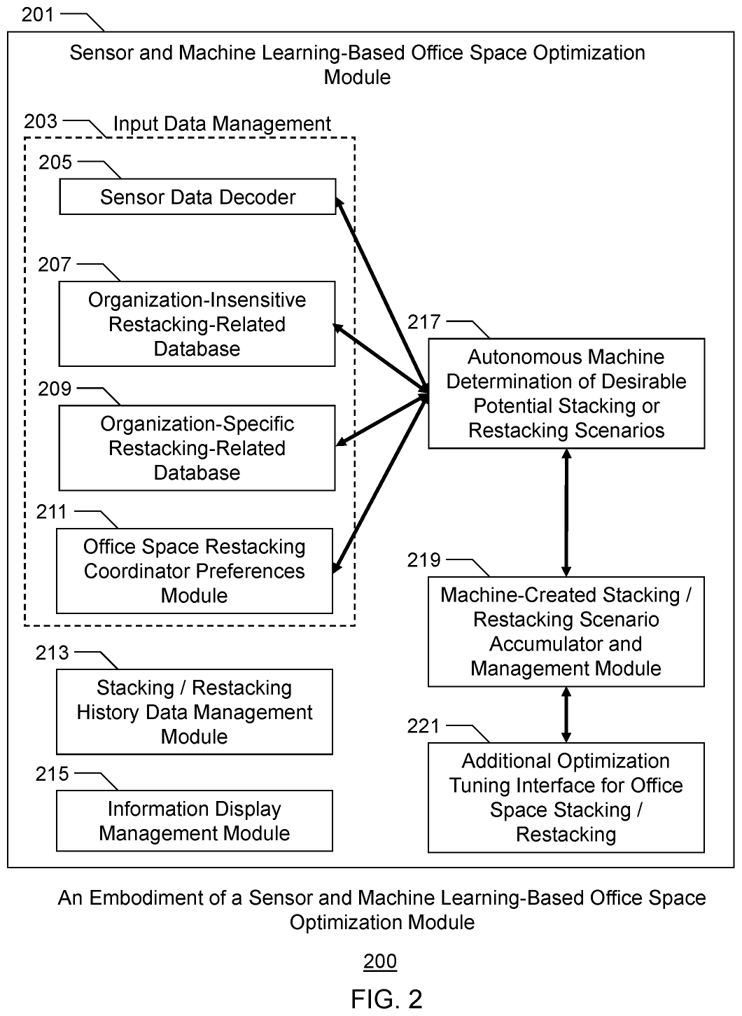

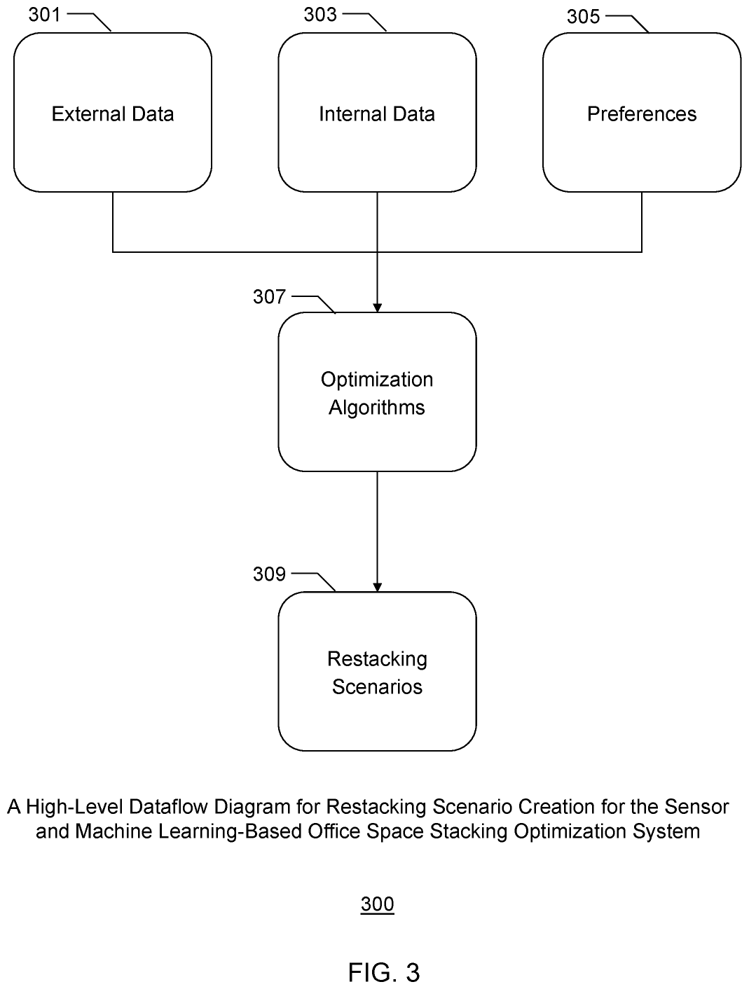

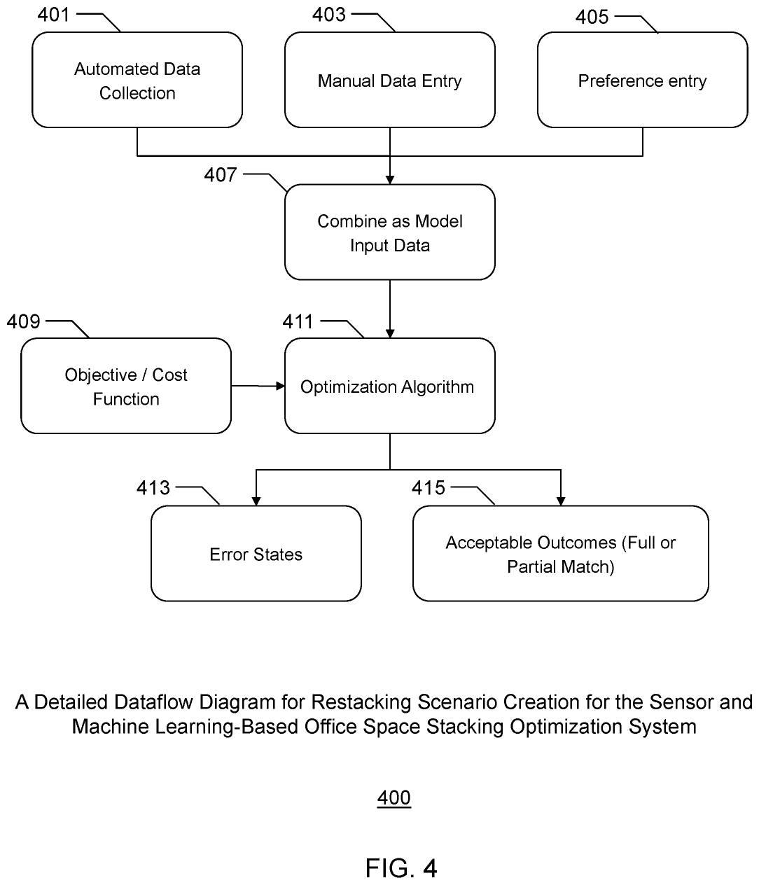

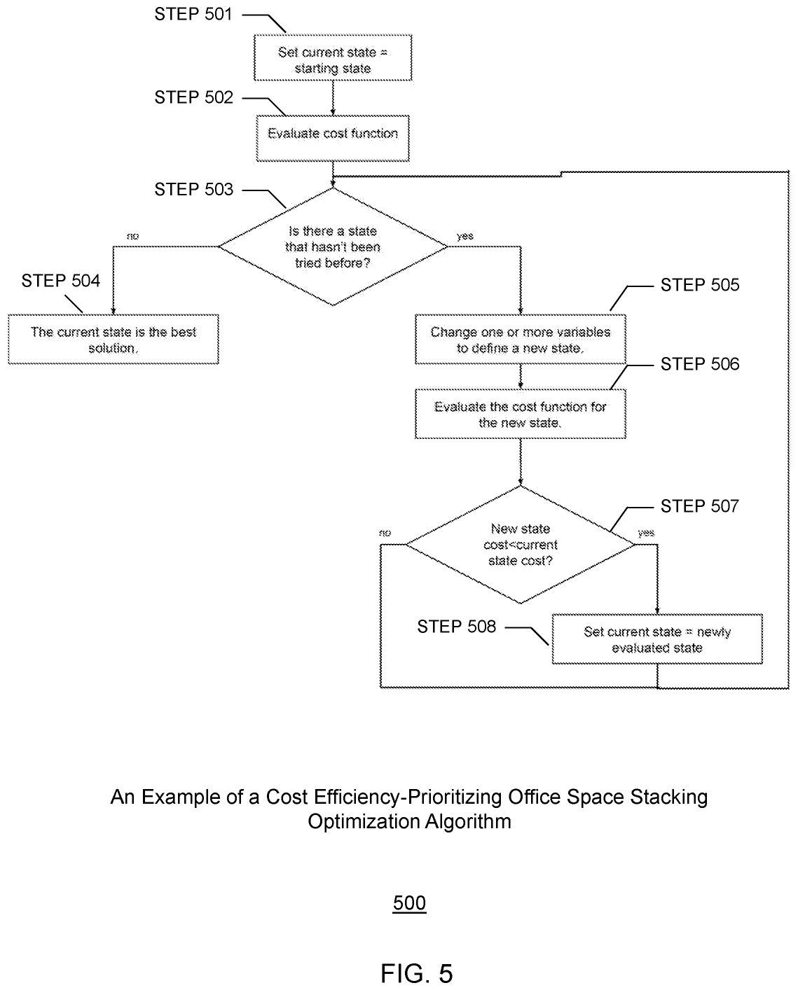

Moreover, in the preferred embodiment of the invention, the sensor and machine learning-based office space stacking optimization module (123) incorporates a sensor data decoder operatively connected to a human or object detection sensor (e.g. 103, 107, 111), an organization-insensitive restacking database (e.g. 207 in FIG. 2), an organization-specific restacking database (e.g. 209 in FIG. 2), an office space restacking coordinator preferences module (e.g. 211 in FIG. 2), a restacking history data management module (e.g. 213 in FIG. 2), a machine-created restacking scenario accumulator and management module (e.g. 219 in FIG. 2), and an autonomous machine restacking determination unit (e.g. 217 in FIG. 2) that discovers, without a human operator intervention, a best-performing potential restacking scenario (e.g. 309 in FIG. 3, 415 in FIG. 4) for office space cost reduction or worker productivity improvement for the office space. Typically, the best-performing potential restacking scenario is quantified by an optimization algorithm (e.g. 307 in FIG. 3, 411 in FIG. 4, FIG. 5) incorporating an objective or cost function (e.g. 409 in FIG. 4, STEP 506 in FIG. 5) that compares one computer-generated restacking scenario's office space cost reduction or worker productivity improvement against other computer-generated restacking scenarios. In this embodiment, the sensor and machine learning-based office space stacking optimization module (123) is typically executed on the computer server (121), a portable electronic device, or a combination thereof.

FIG. 2 shows an embodiment (200) of a sensor and machine learning-based office space stacking optimization module (201), in accordance with an embodiment of the invention. In this preferred embodiment of the invention, the sensor and machine learning-based office space stacking optimization module (201) incorporates an input data management block (203) that comprises a sensor data decoder (205), an organization-insensitive restacking-related database (207), an organization-specific restacking-related database (209), and an office space restacking coordinator preference module (211).

As shown in this embodiment (200), the sensor data decoder (205) is configured to receive and decode various sensor data readouts transmitted from a plurality of sensor devices (e.g. 103, 107, 111 in FIG. 1). The decoded sensor data are then sent to an autonomous machine determination block (217) for creating desirable potential stacking or restacking scenarios. Similarly, the organization-insensitive (i.e. external) restacking-related database (207) and the organization-specific (i.e. internal) restacking-related database (209) receive, categorize, and store various organization-insensitive and organization-specific datasets that can be queried and accessed by the autonomous machine determination block (217) during synthesis of desirable potential stacking or restacking scenarios. Furthermore, the office space restacking coordinator preference module (211) provides an electronic user interface to allow a human coordinator to enter any major objectives, orders of importance, and/or other subjective preferences for office space stacking/restacking considerations relative to the status quo of the current office arrangements. The office space restacking coordinator preference module (211) is also configured to receive, categorize, and store various human coordinator-provided preferences that can be subsequently queried and accessed by the autonomous machine determination block (217) during synthesis of desirable potential stacking or restacking scenarios.

Based on various input data provided by the input data management block (203), the autonomous machine determination block (217) is able to create a plurality of desirable potential stacking or restacking scenarios and store and categorize such scenarios in a machine-created stacking/restacking scenario accumulator and management module (219). In the preferred embodiment of the invention, the human coordinator is able to access, select, and/or simulate one or more autonomous machine-generated potential stacking/restacking scenarios stored in the machine-created stacking/restacking scenario accumulator and management module (219) via an electronic user interface generated on a display panel connected to a computer server or a portable electronic device, which executes at least part of the sensor and machine learning-based office space optimization module (201). Furthermore, an additional optimization tuning interface (221) can also be generated by the sensor and machine learning-based office space optimization module (201) and enable the human coordinator to modify and/or fine-tune the autonomous machine-created stacking/restacking scenarios.

In addition, the sensor and machine learning-based office space optimization module (201) may also include a stacking/restacking history management module (213) that categorizes and archives previously-presented stacking/restacking scenarios by case numbers, case identifiers, calendar dates, restacking objectives, and/or specific operator names. Moreover, the sensor and machine learning-based office space optimization module (201) may also incorporate an information display management module (215) configured to display electronic user interfaces and various stacking/restacking scenarios synthesized by the sensor and machine learning-based office space optimization module (201).

FIG. 3 shows a high-level dataflow diagram (300) for restacking scenario creation (309) for the sensor and machine learning-based office space stacking optimization system, in accordance with an embodiment of the invention. As illustrated in the high-level dataflow diagram (300), the restacking scenario creation (309) involves three types of input parameters: external data (301), internal data (303), and system user preferences (305). Then, the sensor and machine learning-based office space stacking optimization system executes one or more office space, productivity, and/or cost efficiency improvement/optimization algorithms (307) to generate various restacking scenarios, which a system user can ultimately select to implement in real life for an organization's office space stacking or restacking efforts.

The external data (301) in this high-level dataflow diagram (300) for restacking scenario creation (309) are organization-insensitive input parameters (e.g. 113 in FIG. 1, 207 in FIG. 2), which are typically not unique to the organization itself and are relevant in evaluating restacking options. In one embodiment of the invention, the external data (301) include local traffic information to a particular office space location. The local traffic information can subsequently be combined with employee data (i.e. an organization-specific parameter from the internal data (303)) to determine a stacking/restacking scenario's impact of employee commute times, which in turn may influence the overall productivity and efficiency of the organization. Another example of the external data (301) is construction cost information, which estimates the cost of re-fitting an office space for restacking one or more teams, departments, or all employees. In this example, a computer-generated restacking scenario that simulates relocating the Sales Department of an organization to a new floor may require re-fitting the new floor with more meeting rooms or phone booths than staying in the current location.

Another example of the external data (301) is cost parameters associated with office space or building equipment installation, change, and related labor costs. For instance, moving the Engineering Department to an adjacent building may require the building's electric panel upgrade and the HVAC system upgrade to support more research and development (R&D)-related power consumption, cooling, heating, and/or ventilation needs. Furthermore, another example of the external data (301) is office space lease cost data that also reflect on lease cost trends. For instance, the lease cost trends may suggest lease prices rising, falling, or changes in contractual flexibility of a lease (e.g. Any options to sub-lease floor if the organization ends up with unused space? If the sub-lease is allowed, is the sub-lease likely to cover a significant portion of the overall lease cost?).

In addition, the external data (301) input parameters for the restacking scenario creation (309) by the sensor and machine learning-based office space stacking optimization system can also include local demographic data that suggests the prospects of finding and hiring the right talent at a potential new office location. Moreover, the external data (301) input parameters may also include the cost of relocating a particular individual to the potential new office location, and tax implications (e.g. tax rates, incentives, depreciation, and amortization rules, etc.) associated with the potential new office location. These external data (301) input parameters enhance accuracy and relevancy of machine-determined and computer-simulated office stacking/restacking scenarios (309) that are optimized for one or more objectives of office space rearrangements (e.g. cost reduction, productivity improvements, etc.).

Continuing with the high-level dataflow diagram (300) for restacking scenario creation (309) in FIG. 3, the internal data (303) are organization-specific input parameters (e.g. 115 in FIG. 1, 209 in FIG. 2) that are particular to the organization evaluating machine-determined and computer-simulated restacking options. The internal data (303) are typically automatically collected from various corporate computer systems and applications that embody the organization's particular operational and cost-related characteristics. In one embodiment of the invention, the internal data (303) may include current real estate/office space footprint information (e.g. lease costs, critical dates, maximum occupancy capacities associated with currently-leased or utilized sites, buildings, and/or floors for the organization), other operational costs associated with buildings (e.g. utility expenses, taxes, janitorial service expenses, food and beverage costs, security costs, etc.), current real estate usage information that outlines detailed items on each floor (e.g. types, sizes, and current allocations of office space assets (e.g. desk, cubicle, office, meeting room, storage room, etc.) on each floor), and present or future space allocation information for a plurality of employees and/or business units within the organization.

Furthermore, the internal data (303) may also include organization structure information, current and projected future headcounts for various business and/or planning units for each site used by the organization, and cost estimates for disrupting an employee's work during a relocation activity, if a particular restacking scenario generated in the computer simulation were to be executed in real life. For instance, mandating an office relocation to a sales person may cost $2,000 per day due to lost productivity and disruptions during the relocation process, while a similar type of office relocation mandated to a customer service person may only cost $500 per day due to lost productivity and disruptions during the relocation process.

Moreover, in one embodiment of the invention, the internal data (303) may also include employee and other personnel meeting data collected automatically from an enterprise calendar such as Microsoft Exchange, Office 365, or Google G-Suite that indicate historical and/or real-time demand levels for meeting spaces by specific employees and/or other individuals, the size of each meeting, the frequency of employee or personnel meetings, and the collaborative tendencies among employees. In addition, the internal data (303) may also include attendance information collected and analyzed from an employee/personnel access control system such as badging systems, indicating how often individuals spend time in a particular office location (e.g. typically 3 days a week in assigned location, 1 day from a different office location, and another day from home).

The internal data (303) for restacking scenario creation in FIG. 3 may also include office space utilization data collected and analyzed through integration with automated IoT devices such as passive infrared (PIR) sensors, machine-vision sensors, Bluetooth beacons, and WiFi access points. Various sensory readout values from these automated IoT devices can be analyzed by the environmental sensor and machine learning-based office space stacking optimization system to autonomously determine office equipment and space type requirements, even without human operator interventions. For example, the system can autonomously and intelligently determine which particular group of engineers, scientists, or marketers in the organization needs server rooms, lab spaces, and/or storage areas, based on the sensory readout values from the PIR sensors, machine-vision sensors, Bluetooth beacons, and WiFi access points.

Continuing with the high-level dataflow diagram (300) for restacking scenario creation in FIG. 3, the system user preferences (305) are provided by system operators or users who are interested in receiving various computer-simulated office space and organizational restacking scenarios (309) from the sensor and machine learning-based office space stacking optimization system. In one embodiment of the invention, the system user preferences (305) indicate various imperatives or desires from the organization itself to achieve the office space optimization process. One example of the system user preferences (305) is an “adjacency” parameter. The adjacency parameter indicates which business or planning unit in an organization needs to be in close proximity to other specific business or planning units, preferably as a numerical scale that suggests relative importance of each potential adjacency. For instance, Business Unit A being on the same floor as Business Unit B may not be necessary, while these two business units staying in the same building is essential to system operators. In this case, the adjacency priority of these two business units for being on the same floor is given a medium to low is numerical score for the adjacency preferences, while the adjacency priority of these two business units for being in the same building is assigned the highest numerical score possible for the adjacency preferences.

Another example of the system user preferences (305) is a target location parameter, which enables the system operators/users to indicate preferences of a specific business unit or a part of that business unit for placement at particular site(s), building(s), and/or floor(s) occupied by the organization, in the order of increasing or decreasing preferences for a plurality of available locations. Moreover, the system user preferences (305) may also include a “do not move” preference parameter to ensure that certain people or groups are not to be relocated from their current office locations. In some embodiments of the invention, the system user preferences (305) may also be inferred from the other datasets that identify groups that should be in physical proximity together to reduce collaboration overhead, and the amount of office space a specific group requires based on the group's general workflow patterns in one office location vs other locations.

Furthermore, the system user preferences (305) in the sensor and machine learning-based office space stacking optimization system can also be tagged with flags that indicate the intensity of preferences, such as a “must have” flag, or a merely “desired” flag, and ranked according to their relative importance. For example, the following system user preferences rank may define the intensity of the user preferences in the order of decreasing importance or priority (i.e. with a lower number indicating a higher preference priority): 1. Business unit A on the same floor as business unit B (must), 2. Business unit C in the same building as business unit B (strongly desired), 3. Business unit D on the same floor as business unit C (somewhat desired).

Continuing with the embodiment of the invention as shown in FIG. 3, the sensor and machine learning-based office space stacking optimization system is configured to execute one or more office space, productivity, and/or cost efficiency improvement/optimization algorithms (307) to generate various restacking scenarios, which a system user can ultimately select to implement in real life for an organization's office space stacking or restacking efforts. In this embodiment of the invention, an optimization algorithm seeks an optimal configuration of input variables so that the objective function is either minimized or maximized (e.g. minimized in the cost efficiency prioritization example given in FIG. 5). Since a typical model may contain a large number of variables of varying ranges that may be continuous or discrete, and often contain complicated conditional values, specialized algorithms (i.e. familiar to those skilled in the art) are used to seek the optimal configuration.

For example, FIG. 5 illustrates an example of a “hill climbing” optimization algorithm (500), which may be particularly useful for a stacking optimization that prioritizes cost efficiency. In this algorithmic example, the hill climbing optimization algorithm (500) first sets the starting state as the current state, as shown in STEP 501, and evaluates the initial cost function of the starting state, as shown in STEP 502. If there is an additional state remaining that has not been tested for autonomous machine determination of cost efficiency beyond the currently-tested state, as shown in STEP 503, then the hill climbing optimization algorithm (500) changes one or more variables to define a new state, as shown in STEP 505, and then evaluate the cost function for the new state, as shown in STEP 506.

After the machine's autonomous evaluation of the cost function for the new state, if the new state costs less (i.e. more cost efficient) than the current state cost, as shown in STEP 507, then the newly-evaluated state is now set to be the current state, as shown in STEP 508. The hill climbing optimization algorithm (500) then loops back to the beginning of STEP 503 and continues the feedback loop logic to determine the most cost-efficient state, until there is no remaining state that has not been tested by the algorithm, as shown in FIG. 5. At the exiting point of the feedback loop, the state assigned as the “current state” is determined to be the most cost efficient, or “best” solution for the cost efficiency-prioritizing office space stacking optimization algorithm, as shown in STEP 504.

There are numerous optimization algorithms potentially suitable to work effectively with various embodiments of the present invention for real estate stacking scenario generations. For instance, some system operators may place priority on cost efficiency, while others place priority on minimizing physical distances within an organization or improving overall work productivity of the organization.

FIG. 4 shows a detailed dataflow diagram (400) for restacking scenario creation for the sensor and machine learning-based office space stacking optimization system, in accordance with an embodiment of the invention. As shown in this detailed dataflow diagram (400), the sensor and machine learning-based office space stacking optimization system receives three types of input parameters: an automated data collection (401), a manual data entry (403), and a system user preference entry (405).

In one embodiment of the invention, the automated data collection (401) includes at least one of IoT environmental sensor readouts, organization-insensitive external datasets, and organization-specific internal datasets that involve employee and organizational information. The manual data entry (403) involves a human operator manually entering business, employee, or real estate-related information into the sensor and machine learning-based office space stacking optimization system. In addition, the system user interface entry (405) involves entering various system user preferences parameters (i.e. 305 in FIG. 3), which were previously described injunction with FIG. 3. These input parameters from various sources (i.e. 401, 403, 405) are then combined as a model input dataset (407), which is then fed into an optimization algorithm (411), as shown in FIG. 4.

The optimization algorithm (411) in FIG. 4 seeks to find an optimal stacking scenario according to the objective and/or the cost function(s) (409). The optimization algorithm (411) automatically seeks the best available stacking scenario, given a cost function and the model input dataset (407) from the various sources (i.e. 401, 403, 405). In some cases, a solution that meets all the required criteria may not exist. For example, a user may require Business Unit A and Business Unit B to be on the same floor, but no floor may be big enough to hold the two units' combined employees. In another case, multiple different preferences may not be compatible either in theory or in practice. For example, a system user may require Business Unit A to be both in Building 10 and in Building 11. In another example, the system user may require that Business Units A and B would be in the same floor and that Business Units A and C would be on the same floor, with floors big enough to hold only A and B or A and C, but not all three.

In this situation, the optimization algorithm may follow one or more strategies to loosen some constraints or preferences gradually in order to find a solution that meets as many of the prescribed criteria as possible, even if it cannot meet all of them. One simple example of such a process is repeatedly removing the lowest-priority active constraint until a stacking solution is found that meets the remaining criteria. More sophisticated strategies may involve trying different combinations of active criteria, while trying to get as close as possible to an optimal solution.

The objective function (i.e. 409 in FIG. 4), often used in mathematical optimizations, represents the outcome of an event or the outcome of a set of variables having a specific value as a real number. The objective function may represent cost or loss, in which case it may be referred to as cost or loss function. The objective function may also represent a reward function, a profit function, a utility function, a fitness function, etc. The mathematical optimization would typically seek to minimize cost or loss, or to maximize profit, utility, fitness, etc.

In one example, a simple model representing the cost function in the context of the present invention may include the following variables as inputs:
1. The annual lease and operating cost for floors or a building.
2. The cost of moving an employee from her current seating location to a new one (e.g. cost of boxes, paying porters to move boxes, paying for reconfiguration of the work station, cost of re-routing the network ports, etc.)
3. The cost to the business (for example through loss of productivity) of disrupting the work of an employee from a specific department during the move (disrupting a sales person may cost more to the business than disrupting a customer service representative).
4. The business cost in lost productivity when certain departments (e.g. Sales and Marketing) are not physically placed on the same floor, enabling better collaboration.

Furthermore, in this example, a business may place the following values as input variables:
1. Floor1_Cost=$255,000 (yearly)
2. Floor2_Cost=$195,000 (yearly)
3. Floor3_Cost=$205,00 (yearly)
4. Employee_Move_Cost=$200 (per move)
5. Sales_Disruption_Cost=$5,500 (per day)
6. Marketing_Disruption Cost=$2, 100 (per day)
7. Sales_Marketing_Collaboration=$75,000 (per year)
   With the cost function for evaluating a change to the stacking organization of the three floors looking like:

f=total cost of floors used+(number of moved employees*employee move cost)+(number of Sales employees disrupted*days of disruption*cost of disrupting a Sales employee)+(number of marketing employees disrupted*days of disruption*cost of disrupting a Marketing employee)−cost of Sales & Marketing collaboration if they are not seated on the same floor.

Therefore, in this instance, the optimization algorithm may follow one or more strategies to loosen some constraints or preferences gradually in order to find a solution that meets as many of the prescribed criteria as possible, even if it cannot meet all of them. One simple example of such a process is repeatedly removing the lowest-priority active constraint until a stacking solution is found that meets the remaining criteria. More sophisticated strategies may involve trying different combinations of active criteria, while trying to get as close as possible to an optimal solution.

Continuing with the example described above, the current cost may be the total cost associated with the three floors and the cost of Sales-Marketing departments collaboration incurred by a lack of a single floorspace sharing. In this case, the current cost is $730,000 (i.e. a summation of Variable No. 1, 2, 3, and 7). In this example, the cost function's value for a proposed move after disrupting one day of work among 35 Sales Department employees and disrupting two days of work among 53 Marketing Department employees for relocation to the same floor, while vacating and terminating the lease on the third floor, can be calculated as follows:

$225,000+$195,000+(35*$5,500)+(53*2 days*$2,100)=$835,100

Because the proposed organizational relocation has a higher cost than the status quo (i.e. the current cost of $730,000) when the objective/cost function is utilized, this particular walk-through example indicates that the proposed relocation plan should not be implemented, when cost/benefit ratio is considered over one-year period.

The system may run multiple variation of the cost function as it looks for scenarios, with each cost function modeling a different set of priorities. For example, one cost function variation may put more value on reducing the number of moves and minimizing work disruption; another may put more value on minimizing real estate costs; while yet another may put more relative weight on adjacency requirements. If the optimization algorithm (411) generates useful office stacking scenarios that are a partial match or a full match to the system's objectives as defined in the objective and/or the cost function(s) (409), those useful office scenarios can be flagged as “acceptable outcomes” (415), as shown in FIG. 4. On the other hand, if the optimization algorithm (411) generates undesirable or erroneous results, the system flags such outputs as “error states” (413), as also illustrated in FIG. 4.

Various embodiments of the present invention alleviate the complexity of office space stacking or restacking scenario generation and related corporate real estate planning by providing a novel electronic system that incorporates machine learning and artificial intelligence to synthesize and recommend one or more stacking or restacking scenarios for office space allocations, even without human operator interventions. By performing autonomous machine determinations from various organization-insensitive, organization-specific, user preferential, and real-time sensor readout datasets, the novel electronic system is able to synthesize optimal stacking or restacking scenarios that conform to desired office space stacking or restacking objectives of an organization.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by claims presented herein.

What is claimed is:

1. A sensor and machine learning-based office space stacking optimization system, the system comprising:
a human or object detection sensor installed in an office space to identify or detect presence of one or more employees;
a sensor and machine learning-based office space stacking optimization module comprising a sensor data decoder operatively connected to the human or object detection sensor, an organization-insensitive restacking database, an organization-specific restacking database, an office space restacking coordinator preferences module, a restacking history data management module, a machine-created restacking scenario accumulator and management module, and an autonomous machine restacking determination unit that discovers, without a human operator intervention, a best-performing potential restacking scenario for office space cost reduction or worker productivity improvement for the office space, wherein the best-performing potential restacking scenario is quantified by an optimization algorithm incorporating an objective or cost function that compares one computer-generated restacking scenario's office space cost reduction or worker productivity improvement against other computer-generated restacking scenarios, and wherein the sensor and machine learning-based office space stacking optimization module is executed on a computer server;
an organization-insensitive external dataset entered into the organization-insensitive restacking database in the sensor and machine learning-based office space stacking optimization module;
an organization-specific internal dataset entered into the organization-specific restacking database;
a user-provided office space restacking preference parameter entered into the office space restacking coordinator preferences module in the sensor and machine learning-based office space stacking optimization module; and
a data network operatively connecting the human or object detection sensor in the office space and the sensor and machine learning-based office space stacking optimization module executed in the computer server.

2. The sensor and machine learning-based office space stacking optimization system of claim 1, further comprising an information display management module incorporated into or connected to the sensor and machine learning-based office space stacking optimization module to display the best-performing potential restacking scenario on a display panel.

3. The sensor and machine learning-based office space stacking optimization system of claim 1, further comprising one or more computerized interfaces to provide the organization-insensitive external dataset, the organization-specific internal dataset, and the user-provided office space restacking preference parameter to the sensor and machine learning-based office space stacking optimization module.

4. The sensor and machine learning-based office space stacking optimization system of claim 1, wherein the human or object detection sensor installed in the office space is a passive infrared (PIR) sensor, a machine-vision sensor, a Bluetooth-based beacon, or a combination thereof.

5. The sensor and machine learning-based office space stacking optimization system of claim 1, wherein the optimization algorithm incorporating the objective or cost function prioritizes the office space cost reduction by deriving a cheapest office lease cost structure in the best-performing potential restacking scenario.

6. The sensor and machine learning-based office space stacking optimization system of claim 1, wherein the optimization algorithm incorporating the objective or cost function prioritizes the worker productivity improvement by discovering a computer-generated restacking scenario with minimal employee commute time to the office space, minimal travel distances between collaborative business groups, best office equipment and business group matchups, minimal operational disruptions during an actual employee relocation process based on the computer-generated restacking scenario, or a combination thereof.

7. The sensor and machine learning-based office space stacking optimization system of claim 1, wherein the optimization algorithm involves a “hill climbing” optimization method.

8. The sensor and machine learning-based office space stacking optimization system of claim 1, wherein the data network is a cellular communication network, a wireless LAN, a satellite communication network, a wired cable communication network, or a combination thereof.
